(19) United States
(12) Patent Application Publication
(10) Pub. No.: US 2020/0072190 A1
(43) Pub. Date: Mar. 5, 2020

(54) VERTICAL AXIS WIND TURBINE

(71) Applicant: Shannon R. Buchanan, Mechanicsburg, OH (US)

(72) Inventor: Shannon R. Buchanan, Mechanicsburg, OH (US)

(21) Appl. No.: 16/559,364

(22) Filed: Sep. 3, 2019

Related U.S. Application Data
(60) Provisional application No. 62/725,339, filed on Aug. 31, 2018.

(51) Int. Cl. F03D 3/00; F03D 3/06; F03D 9/25; F03D 15/10

(52) U.S. Cl. CPC F03D 3/005; F03D 3/068; F03D 9/25; F03D 15/10; F05B 2220/706; F05B 2240/9121; F05B 2260/72; F05B 2260/506; F05B 2240/215

(57) ABSTRACT

The vertical wind turbine and system generally comprises a rotor assembly having a plurality of blades, a fixed central spindle having a central axis for supporting rotation of the rotor assembly, a blade adjustment mechanism assembly for adjusting the blade angle of attack throughout rotation of the rotor assembly, and a support framework for supporting the rotor assembly at an elevated position in order to gain access to a sustained source of wind. The wind turbine may be operably coupled with a power electric generator or other device which transfers mechanical energy into electrical energy as a combined system.

### FIELD OF THE INVENTION

The present invention relates to the field of wind turbines, and more specifically, to a vertical axis wind turbine and methods of operating vertical axis wind turbines.

### BACKGROUND

Wind energy is a fast-growing renewable resource that will play a factor in reducing the world's reliance on fossil fuels. The wind industry is growing on a global and national level. The United States Department of Energy (DOE) aims for 20% of the nation's electricity to be produced from wind by 2030. The DOE also states that “greater use of the nation's abundant wind resources for electric power generation will help the nation reduce emissions of greenhouse gases and other air pollutants, diversify its energy supply, provide cost-competitive electricity to key regions across the country, and reduce water usage for power generation.” Wind energy is a fast-growing renewable resource that will play a factor in reducing the world's reliance on fossil fuels.

Generally speaking, wind turbines are used to convert the kinetic energy of the wind to power by use of turbine blades rotatably arranged on a drive shaft. The wind exerts a force on the turbine blades, which by rotation of the turbine blades is transformed to a torque about the longitudinal axis of the drive shaft driving the drive shaft. The rotating drive shaft is connected to a generator to produce electrical power or any other form of power medium.

Numerous designs of wind turbines have been presented. Generally, these designs fall in two categories, i.e. horizontal axis wind turbines or vertical axis wind turbines. Most common are horizontal axis wind turbines, wherein the turbine blades are arranged in a propeller-like manner about the longitudinal axis of the horizontal drive shaft forming a rotor, which is placed at the top of a tower structure. The rotor has to be pointed in the direction of the wind. Usually, the generator and/or a gearbox, which converts the rotation speed of the blades to a rotation speed more convenient for power generation, are placed at the top of the tower. Vertical axis wind turbines have turbine blades arranged in a carousel manner about the longitudinal axis of the drive shaft, which is directed perpendicular to the direction of the wind. Usually, the drive shaft is vertical, although the drive shaft also can be placed horizontally.

Moreover, the horizontal axis wind turbine has the highest coefficient of performance currently available and operates by producing lift. Lift is a force that is perpendicular to the fluid motion on the airfoil. In order for the turbine blade to rotate faster, the wind lift force must exceed the drag force. The drag force is parallel to the relative velocity and is present throughout the whole circle of rotation. Lift force, however, is only present when there is a low-pressure zone on one side of the airfoil. This means that there are zones in a full revolution where no lift is produced.

The main issue with horizontal wind turbines are the cost and the fact that the power generator and other electrical equipment are located generally at the top of a tower. This makes maintenance difficult, so the operation and maintenance costs of new turbines are 20-25% of the annual profit. Turbine maintenance can take 1 to 7 days of downtime for each repair depending on the part that needs to be replaced. In addition to downtime required for maintenance, the structure that supports the turbine needs to be sturdy enough to hold up the heavy generator equipment as well. For example, a structure of a small turbine that is only eighty feet tall accounts for approximately 30 percent of the total system cost.

For the foregoing reasons, there is a need for a wind-powered turbine that can be maintained at a low cost while producing more power than a traditional horizontal wind turbine which provides superior airflow and lift characteristics.

### SUMMARY

The vertical wind turbine and system generally comprises a rotor assembly having a plurality of blades, a fixed central spindle having a central axis for supporting rotation of the rotor assembly, a blade adjustment mechanism assembly for adjusting the blade angle of attack throughout rotation of the rotor assembly, and a support framework for supporting the rotor assembly at an elevated position in order to gain access to a sustained source of wind. The wind turbine may operably coupled with a power electric generator or other device which transfers mechanical energy into electrical energy as a combined system.

Generally speaking, the blade angle adjustment mechanism is a fully mechanically and autonomously driven and is configured to change the blade rotating angle or relating angle of attack of each blade at each point through the relative circular motion of the turbine depending on wind direction. In other terms, each of the blades are responsive to rotation throughout the rotational path of the rotor assembly to vary the blade angle of attack with respect to the direction of the wind impinging on the rotor assembly, without the need of motors, such as a stepper motor. Preferably, each blade angle of attack changes relative to the instant relative wind direction and is operably configured to provide the maximum instantaneous rotational force applied about the central axis Y causing the rotor assembly to move throughout a cyclical path of motion.

In a certain version of the application, the vertical axis wind turbine comprises: A vertical axis wind turbine comprising: a central axis that extends in a substantially vertical direction; a support framework; a fixed central spindle supported by the support framework; a rotor assembly comprising: a hub assembly disposed about the central axis; a plurality of blades disposed about the central axis, the plurality of blades physically coupled to rotate together about the central axis, each blade having a blade axis about which it rotates; and a plurality of spaced apart arm assemblies connecting the plurality of blades to the hub assembly; an angle adjustment mechanism that is configured to adjust an angle formed between each blade and a radius that extends from the central axis to each blade as the blade rotates about the central axis and as relevant wind velocity and direction changes; the angle adjustment mechanism comprising: a wind vane adaptable to rotate freely about the central axis so as to be substantially aligned with the direction of the wind; at least one cam having a contoured perimeter affixed below the wind vane and disposed about the central axis, wherein the cam rotates in conjunction the wind vane in relation to the direction of the wind, the cam having an interior track operably disposed about the contoured perimeter thereof; a cam bearing operably providing rotation of the wind vane and cam with and relative to the fixed central spindle; a pushrod operably connecting each blade angle with the cam having a proximal end and a distal end; and a track follower operably positioned at the proximal end of each pushrod and operably coupled to follow the interior track throughout the rotational path of the rotor assembly; and wherein each of the blades are responsive to rotation throughout the cyclical path of the rotor assembly to vary the blade angle of each blade with respect to the direction of the wind impinging on wind vain.

In certain versions of the application, the vertical wind turbine may further include an electric generator having a drive shaft; and a drive gear operably affixed to the rotor assembly rotatable about the central axis and operably configured to provide rotational force to the drive shaft of the electric generator.

In other versions, the vertical axis wind turbine may further include one or more batteries operably coupled with the electric generator for storing electrical energy.

In yet other versions of the application, the vertical axis wind turbine may further have a rotor bearing for supporting and providing rotation of the rotor assembly throughout its rotational path of motion, the rotor bearing affixed below the rotor assembly and operably affixed to the elevated platform of the support framework.

In a certain version, the vertical axis wind turbine may further boast a pivot connection operably connecting the distal end of the pushrod and operation of the blade angle, the pivot connection having a rack and pinion type configuration.

In yet another version of the application, the rotor assembly may have a first tier plurality of blades and a second tier of plurality of blades disposed radially about the central axis and operably positioned in line with the respective first tier plurality of blades.

These and other features of the present invention will become readily apparent upon further review of the following specification and drawings.

### BRIEF DESCRIPTION OF THE DRAWINGS

These and other features, aspects, and advantages of the present invention will become better understood with regard to the following description and accompanying figures where:

FIG. 1 is a front perspective view of a version of the vertical axis wind turbine;

FIG. 2 is a front elevation view of the version shown in FIG. 1;

FIG. 3 is a rear elevation view of the version shown in FIG. 1;

FIG. 4 is a left side elevation view of the version shown in FIG. 1;

FIG. 5 is a right side elevation view of the version show in FIG. 1;

FIG. 6 is a top plan view of the version shown in FIG. 1;

FIG. 7 is an up-close cross-sectional view taken at Detail “A” in FIG. 5 of the version shown in FIG. 1;

FIG. 8 is an up-close cross-sectional view taken at Detail “B” in FIG. 5 of the version shown in FIG. 1;

FIG. 9 is an exploded perspective view of the version shown in FIG. 1;

FIG. 10 is a partially unassembled view of the rotor assembly of the version shown in FIG. 1;

FIG. 11 is an unassembled view of the of the support framework of the version shown in FIG. 1;

FIG. 12 is an unassembled view of the support framework and fixed central spindle of the version shown in FIG. 1;

FIG. 13 is a top plan view of the version shown in FIG. 1;

FIG. 14 is an up-close detailed view of the pivot connection assembly taken at Detail “C” in FIG. 13;

FIG. 15 is a front perspective view of a second example version of the rotor assembly having multiple tiers of radially positioned blades;

FIG. 16 is a perspective view of a third version of an arm assembly and blade having multiple tiers of blades;

FIG. 17 is a front perspective view of a fourth version of the vertical axis wind turbine showing multiple tiers of radially spaced blades; and

FIG. 18 is an illustrative example of a version of the vertical axis wind turbine operably coupled to a housing structure.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other versions that depart from these specific details. In other instances, detailed descriptions of well-known devices and methods are omitted so as not to obscure the description of the present invention with unnecessary detail.

The following detailed description is of the best currently contemplated modes of carrying out exemplary versions of the invention. The description is not to be taken in the limiting sense, but is made merely for the purpose illustrating the general principles of the invention, since the scope of the invention is best defined by the appended claims. Various inventive features are described below that can each be used independently of one another or in combination with other features.

Referring now to the figures wherein the showings are for purposes of illustrating a preferred version of the invention only and not for purposes of limiting the same, the present application discloses a vertical axis wind turbine which is efficiently powers a generator for providing electricity, particularly electric to be supplied to a power grid for conducting electrical energy or for storage in high capacity batteries for future use thereof.

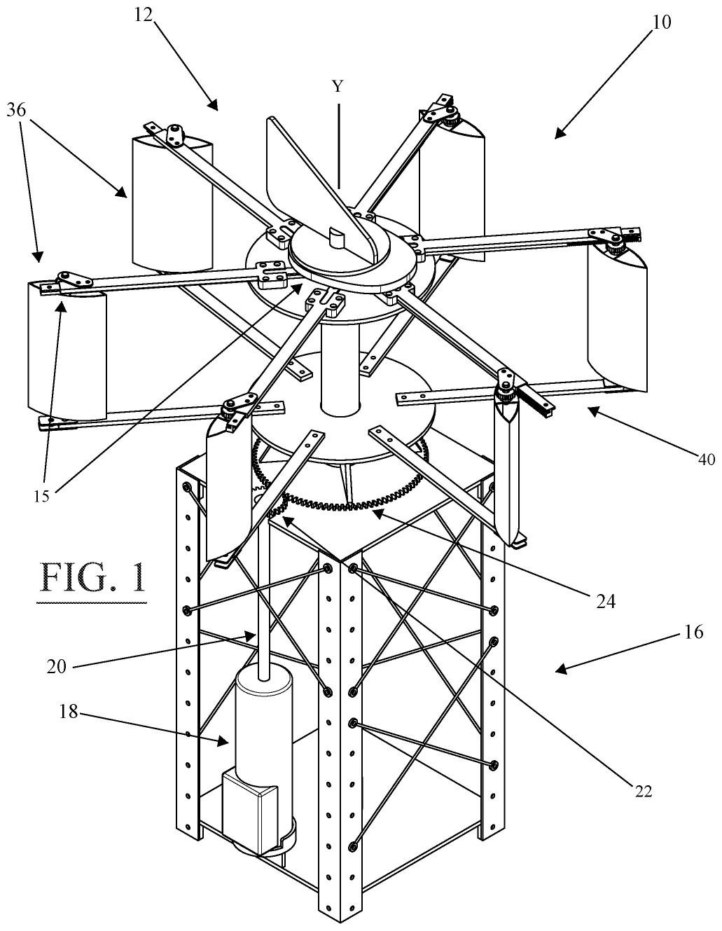

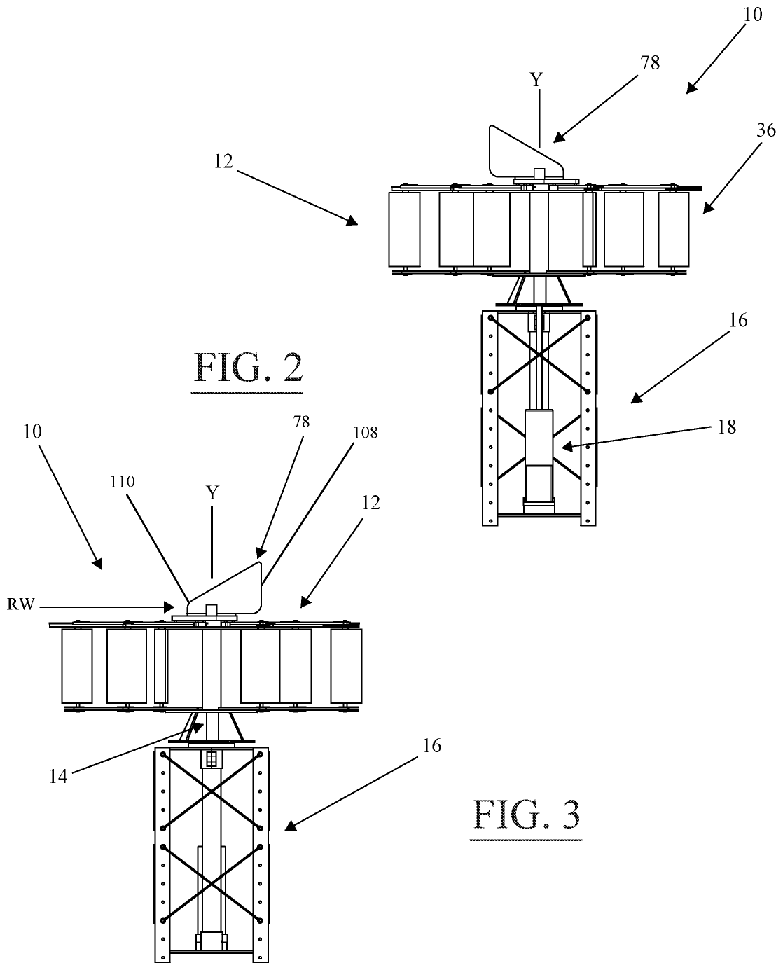

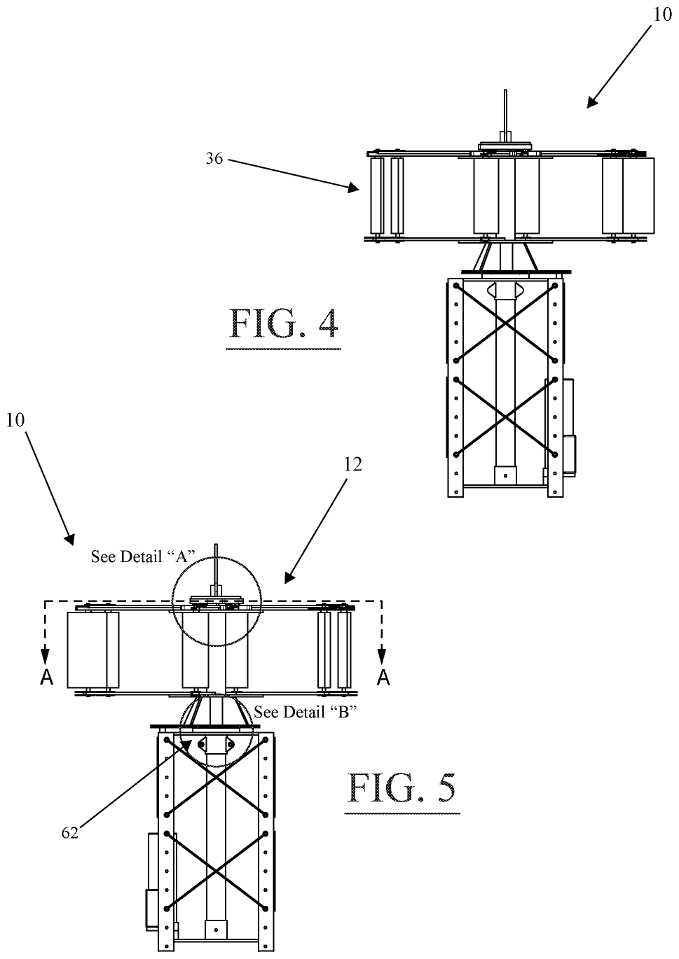

Referring generally to FIG. 1-FIG. 6, in a version of the application the wind turbine 10 and system generally comprises a rotor assembly 12 having a plurality of blades 36, a fixed central spindle 14 having a central axis Y for supporting rotation of the rotor assembly 12, a blade angle adjustment mechanism 15 for adjusting the blade angle of attack throughout rotation of the rotor assembly 12, and a support framework 16 for supporting the rotor assembly 12 at an elevated position in order to gain access to a sustained source of wind. The wind turbine 10 may operably coupled with a power electric generator 18 or other device which transfers mechanical energy into electrical energy as a combined system.

Generally speaking, the blade angle adjustment mechanism 15 is a fully mechanically and autonomously driven and is configured to change the blade rotating angle or relating angle of attack of each blade 36 at each point through the relative circular motion of the turbine 10 depending on wind direction. In other terms, each of the blades 36 are responsive to rotation throughout the cyclical path of the rotor assembly 12 to vary the blade angle of attack with respect to the direction of the wind impinging on the rotor assembly 12, without the need of motors, such as a stepper motor. Preferably, each blade 36 angle of attack changes relative to the instant relative wind direction RW (FIG. 3) and is operably configured to provide the maximum instantaneous rotational force applied about the central axis Y causing the rotor assembly to move throughout a cyclical path of motion.

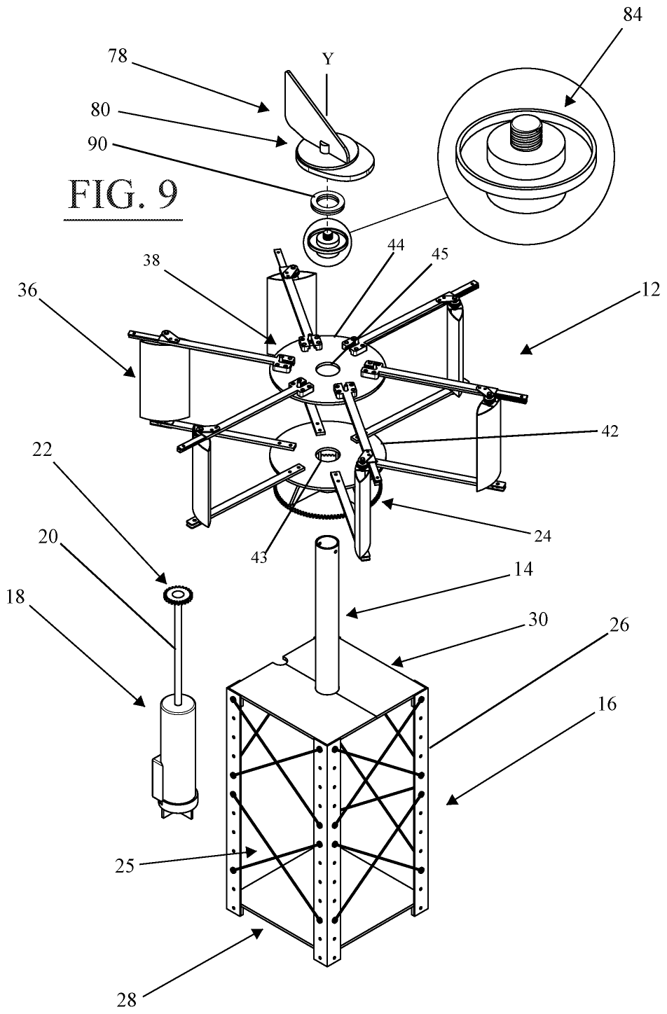

In the illustrated version, the electric generator 18 is ideally positioned below the rotor assembly 12 within the support framework 16 in an upright disposition (See FIG. 1 and FIG. 9). The electric generator 18 can be of any type which converts rotational mechanical energy generated from the wind turbine 10 into electrical energy. For example, a parallel shaft direct current DC gearmotor may be utilized in conjunction with a drive shaft 20 having one or more gears 22 which operate to transfer power from the rotation of the rotor assembly 12 to the drive shaft 20 of the electric generator 18.

With reference to FIG. 9-FIG. 12, the support framework 16 can be constructed in any manner which operably and safely supports the rotor assembly 12 and fixed central spindle 14 among other parts in a vertical operating position. Ideally, the height of the support framework 16 is sufficiently elevated to position the rotor assembly 12 such that it is subjected to a sustained airflow. For example, the support framework 16 may ideally position the rotor assembly 12 a few feet above the respective ground or thousands of feet in the atmosphere in order to gain access to sustained, high-velocity winds.

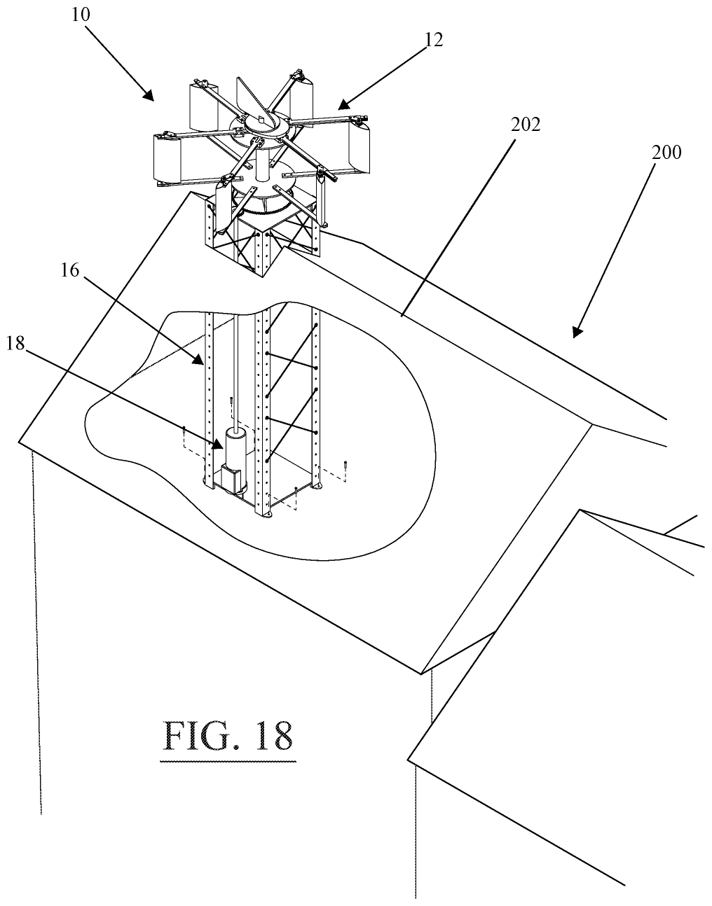

Other variations may be tailored to position the rotor assembly 12 above the roof line of housing or other man-made structures. FIG. 18 illustrates an example support framework 16 which is operably coupled with a home structure 200 roof 202 which places the rotor assembly 12 above the roof line of the home 200, which may be operably configured to provide electrical energy for the illustrated home 200 or building structure provided by the electric generator 18.

Ideally, the support framework 16 is constructed of a combination of woven cables 25 and angle iron 26 which form a rectangular frame having a low coefficient of drag, thereby allowing airflow efficiently pass through the structure (See FIG. 9). In the version, the support framework 16 includes a base platform 28 and an elevated platform 30 positioned there above. The base platform 28 provides support for the electrical generator 18. Preferably, the generator 18 is positioned a sufficient distance from the rotor assembly 12 and other moving parts—mitigating the likelihood of a collision occurring between moving parts and the generator 18 and providing sufficient area for the generator 18 to dissipate heat during operation.

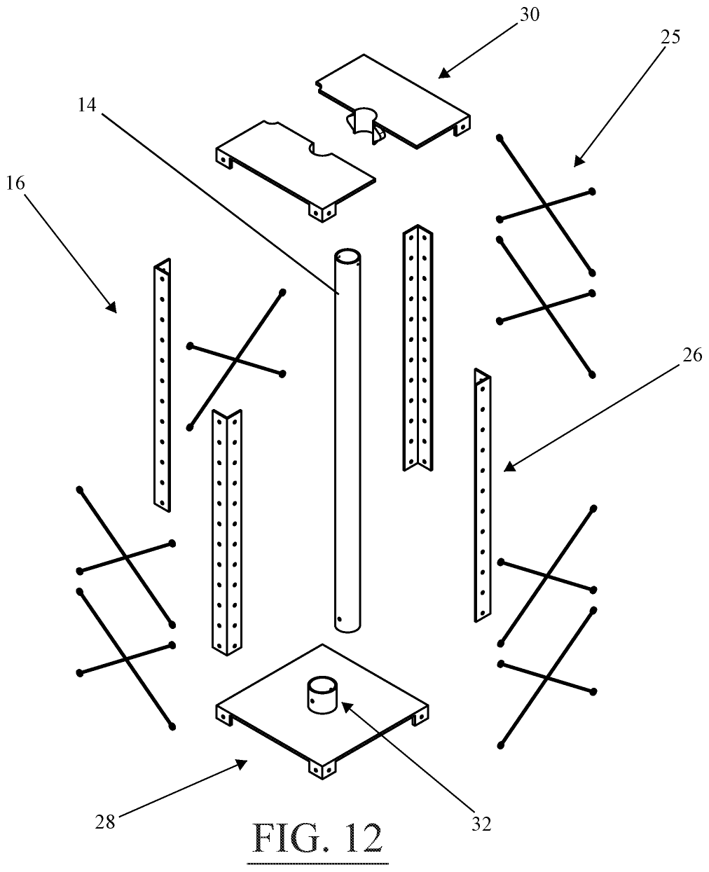

As best illustrated in FIG. 11, the base platform 28 further provides a seating coupler 32 for receiving and positioning the fixed central spindle 14 in a vertical direction. Moreover, the elevated platform 30 provides a cylindrical hole 34 which allows and contains the fixed central spindle 14 for passing vertically therethrough.

Now referring to the figures, particularly FIG. 1, the rotor assembly 12 is constructed to freely rotate about the fixed central spindle 14 and central axis Y through a cylindrical path of rotation. The rotor assembly 12 generally comprises a plurality of blades 36 or airfoils which create lift thereby imparting motion to the rotor assembly 12 and in turn provides motive force to the drive shaft 20 of the electric generator 18.

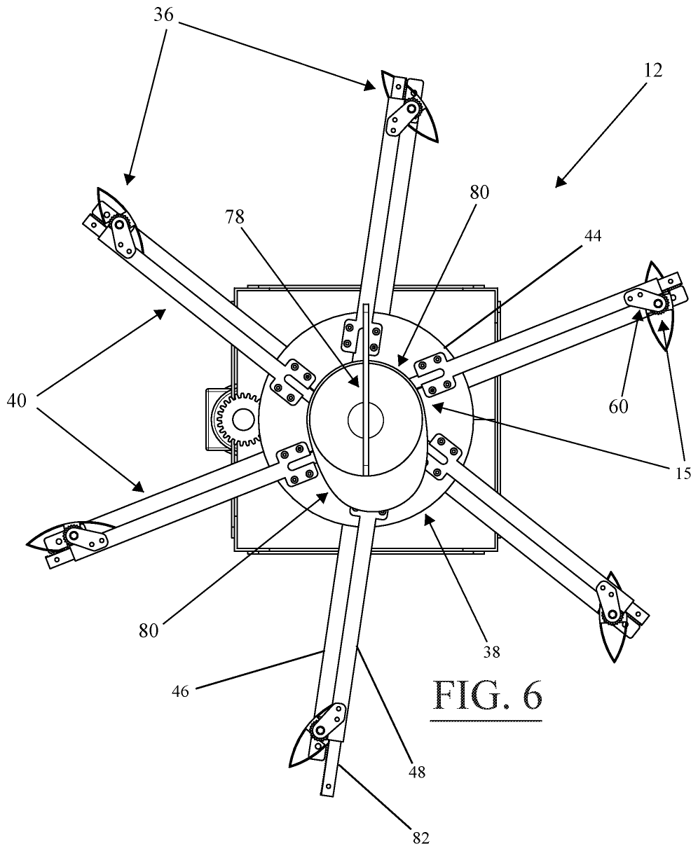

As best illustrated by FIG. 6 and FIG. 9, the rotor assembly 12 is generally configured in a hub and spoke formation—each blade 36 positioned radially from the hub assembly 38 by way of respective arm assemblies 40. In the illustrated version, the hub assembly 38 comprises a lower hub 42 and an upper hub 44. Each hub 42, 44 is shaped in the form of a circular platform including axially aligned holes 43, 45 for receipt of the fixed central spindle 14 resembling the shape of a washer. The hub assembly 38 generally provides radial structural support platform for each arm assemblies 40 to attach with by way of hardware.

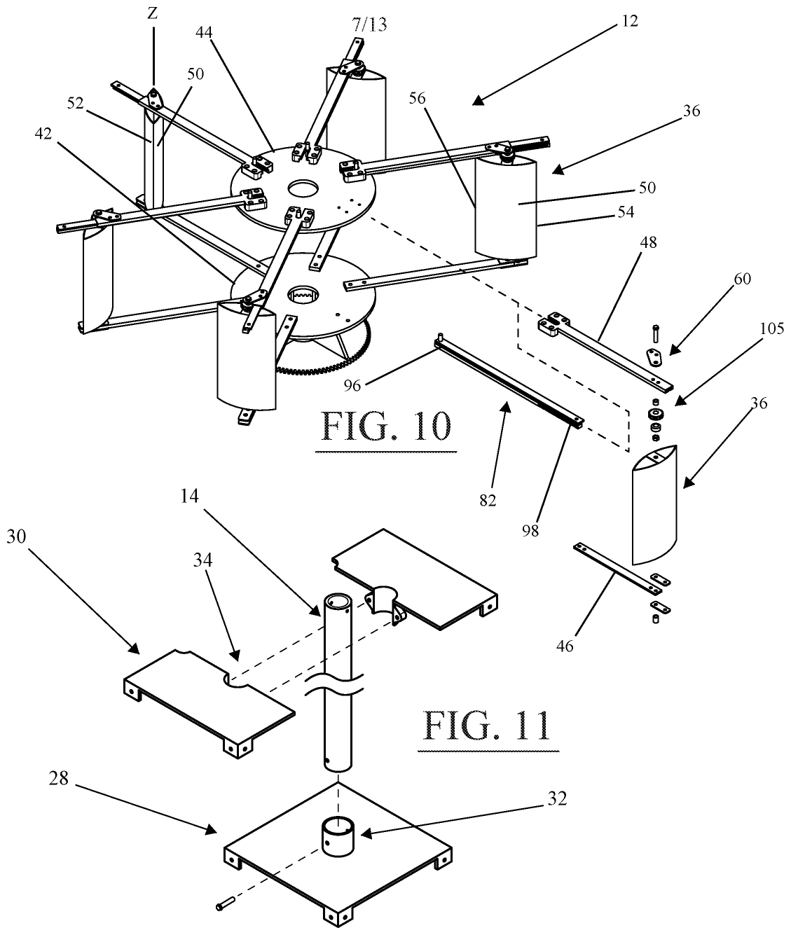

Referring to FIG. 10, the arm assemblies 40 each provide lateral radial positioning and support for each blade 36. In the version, each arm assembly 40 comprises a lower cantilever arm 46 and an upper cantilever arm 48 positioned parallel above and below each other respectively—each fixedly attached to and extending outward from their respective lower and upper hubs 42, 44 forming the radial support of each blade 36. In the version, as best illustrated by FIG. 6, the lower and upper cantilever arms 46, 48 are slightly offset when viewed from the plan perspective for operational purposes further described in detail below.

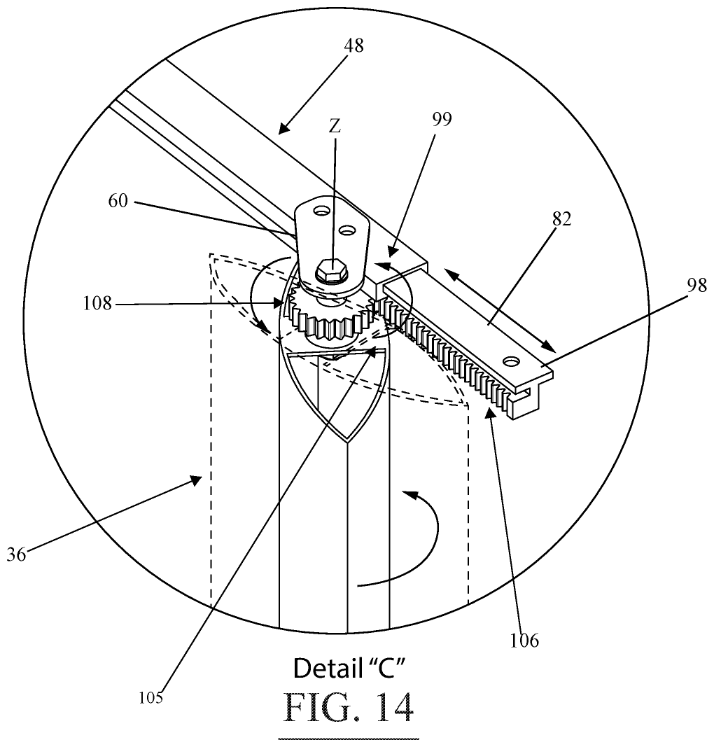

As illustrated in DETAIL C FIG. 14, each arm assemblies further includes an angled support lever 60 positioned at the distal end of each of the upper cantilever arms 48—operably extending to support and rotatably attached to the upper portion of the blade 36 at the blade axis Z. Thus, the lower cantilever arm 46 distal end and the angled support lever 60 provide rotatable axial support of each blade 36 therebetween wherein blade axis Z passes therethrough.

Each of the plurality of blades 36 is equally spaced and vertically disposed about the hub assembly 38 at the distal end of the respective arm assembly 40. Preferably, there are a total of six blades 36 and respective arm assemblies 40; however, other variations are certainly considered. Each blade 36 has a vertical blade axis Z of rotation allowing the blade 36 to pivot relative to the arm assembly 40 as the rotor assembly 12 moves through the operable cyclical path of motion.

Preferably, as best depicted in FIG. 10, generally, each blade 36 is an airfoil having an inner surface 50, outer surface 52, leading edge 54, trailing edge 56, and a chord line 58 formed between the leading and trailing edges 54, 56. The camber of each blade 36, which is the asymmetry between the upper and lower surfaces 50, 52 can vary depending on the application. Moreover, the blade 36 can be symmetrical between the upper and lower surfaces 50, 52 providing an airfoil with no camber as illustrated in the figures.

As best illustrated by FIG. 9, the wind turbine 10 further comprises the drive gear 24 which is affixed to the bottom of the hub assembly 38 and operably positioned to rotate about the central axis Y in conjunction the operation of the rotor assembly 12. As depicted in FIG. 1, the drive gear 24 is coupled to cooperate with the generator gear 22 located at the end of the drive shaft 20 of the generator 18. Thus, as the rotor assembly 12 moves through the cyclical path of motion, the rotation of the drive gear 24 provides rotational energy to the drive shaft via the generator gear 22. Ideally, the gear ratio between the generator gear 22 and the drive gear 24 is 12:1.

In the illustrated version best illustrated by FIG. 5 and FIG. 8, the rotor assembly 12 may further include a rotor bearing 62 or angular bearing for supporting and providing rotation of the rotor assembly 12 throughout its cyclical path of motion. In the version, the rotor bearing 62 is positioned at the bottom of the rotor assembly 12 and operably attached to the top surface of the elevated platform 30 of the support frame 16. The rotor bearing 62 generally comprises an outer race 66, and inner race 68, a cage retainer 70, a plurality of balls 72, and lubricant 74 (See FIG. 8). The outer race 66 fixedly attached to the elevated platform 30 and the inner race 68 operably affixed to the rotor assembly 12. Thus, the rotor assembly 12 is rotatably supported by the platform 30 and rotor bearing 62 throughout the path of rotation. Ideally, the rotor bearing 62 is a thrust bearing which permits rotation between parts, but are designed to support a predominantly axial load.

Now with reference to FIG. 1-FIG. 9, the vertical axis wind turbine 10 further comprises a blade angle adjustment mechanism 15—which generally functions to control the angle of attack of each blade based on the wind direction and radial position throughout the rotor assembly 12 cyclical path of motion. The angle of attack is defined as is the angle between the chord line of the airfoil and the vector representing the relative motion between the body and the fluid (airflow) through which it is moving. For example, when the blade 36 rotates at different points throughout the rotor assembly 12 cyclical path of rotation, the blade's 36 angle of attack is automatically adjusted for any position relative to the wind direction for ideal lift and drag characteristics. The preferable angle of attack at each position throughout the rotational path is relatively based on the blade rotating angle which is set between the blade's 36 chord line and the radius that extends from the central axis Y. See U.S. Pat. No. 7,780,411 and U.S. patent application 2017/0051720 for further clarification.

In the illustrated version, the blade angle adjustment mechanism 15 generally comprises a rotationally independent wind vane 78, a cam 80 operably affixed below the wind vane 78 having a rotational axis R which is axially aligned with the central axis Y, and a plurality of pushrods 82 operable between the cam 80 and the respective blades 36.

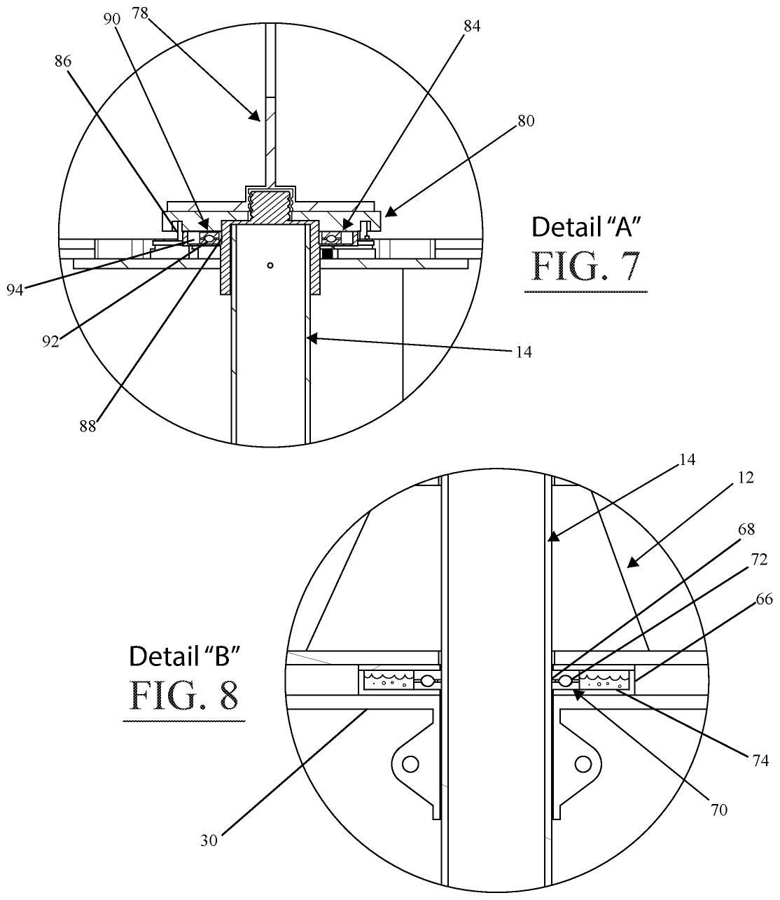

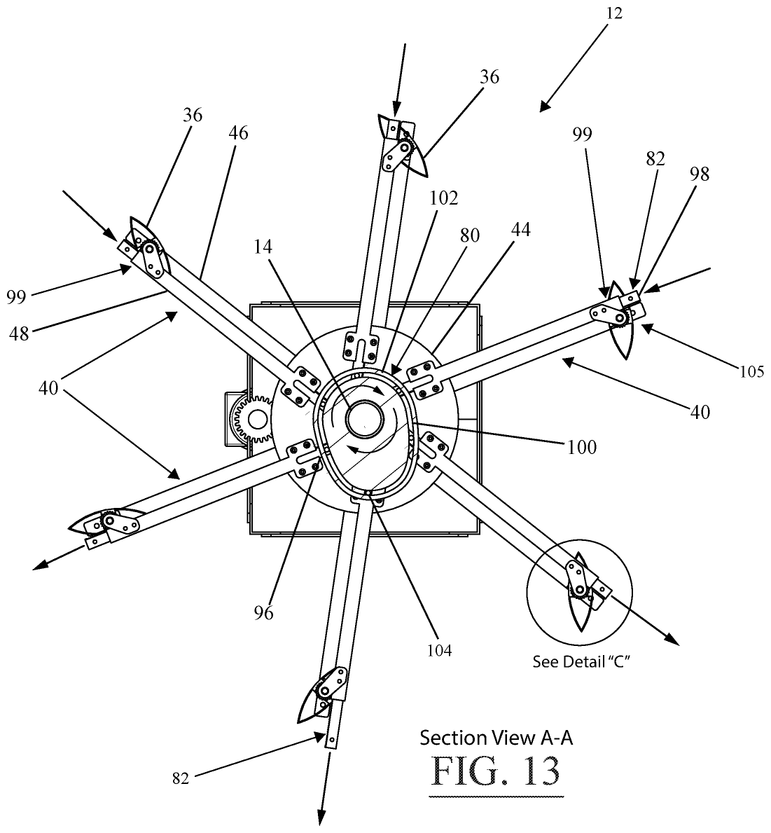

As best illustrated by FIG. 13, the cam 80 is rotatably positioned about the central axis Y above the upper hub 44 of the rotor assembly 12. The cam 80 is freely rotatable about the central axis Y and is independent of the rotation of the rotor assembly 12 by way of a cam bearing 84 (See FIG. 7). Specifically, the bearing 84 provides support and rotation of the wind vane 78 and cam 80 throughout a circular path of motion. In the version the bearing 84 operably couples the cam 80 with the distal end of the fixed central spindle 14. The bearing 84 generally comprises an outer race 86, an inner race 88, a cage retainer 90, a plurality of balls 92, and lubricant 94. The outer race 86 fixedly attached to the distal end of the central spindle 14 and the inner race 88 operably affixed to the cam 80 and wind vane 78. Thus, the cam 80 and wind vane 78 are rotatably supported by the fixed central spindle 14 bearing 84 throughout the path of rotation thereof. The cam bearing 84 is ideally a rotor or angular type bearing.

FIG. 10 and FIG. 13 show a perspective view and a top plan view of the vertical wind turbine 10 and more specifically illustrates how each pushrod 82 connects between the cam 80 and the respective blade 36 via upper cantilever arm 48. Generally, the pushrod 82 is an elongated linear rod having a proximal end 96 extending away from the central axis Y and—in the version—encased within the respective upper cantilever arm 48 terminating at a distal end 98. The upper cantilever arm 48 provides dual purposes—supporting for the respective blade 36 and functions as a sleeve for the respective pushrod 82 contained therein.

The cam 80 provides an interior track 100 which is disposed in and follows the outer contour of the cam 80 perimeter 102. Positioned at the proximal end 96 of each pushrod 82 is a cam follower 104 which is operably configured to follow the interior track 100 of the cam 80 throughout the rotational path of the rotor assembly 12. Further, as depicted in FIG. 14, the distal end 98 of the pushrod 82 provides a pivot connection assembly 105. In the version, the pivot connection assembly 105 comprises a linear rack gear 106 which operably engages with a pinion gear 109 which is positioned atop the respective blade 36 configured to impart rotation thereto about the blade axis Z. Thus, generally, as the rotor assembly 12 moves through its cyclical path of motion, the cam followers 104 move through the interior track 100, thereby moving each pushrod 82 either radially outward or radially inward along their linear path of motion based on the contour of the cam 80 and distance the cam follower 104 is with respect to the rotational axis R of the cam 80 (See FIG. 13). Preferably, the interior track 100 is used as opposed to other cam designs to assist with balancing the push and pull affect of each of the pushrods 82 throughout the irregular path of the interior track 100. Thus, throughout rotation, a portion of the pushrods 82 are actively pulled towards the central axis Y by the interior track 100 while the remaining portion of the pushrods 82 are being actively pushed away from the central axis Y. Thus, significantly reducing the net force applied about the cam 80 throughout operation.

As discussed above and referring to FIG. 3, the wind vane 78 is affixed above the cam 80, wherein the wind vane 78 and the cam 80 rotate together about the central axis Y freely depending on the direction of the impinging relative wind RW. The wind vane 78 is vertically disposed and is operably configured to gravitate into the wind determining wind direction. In the version, the wind vane 78 is a thin triangular shaped structure having a heightened rear portion 108 which tapers downward to a front point 110, wherein as airflow is introduced to the wind vane 78, the thin triangular profile causes the front point 110 to align and point in the opposite direction of the relative wind RW. Generally speaking, the wind vane 78 can range in size from having a small profile for smaller, low velocity wind applications and larger profiles for larger, high velocity wind applications.

Generally, the vertical axis wind turbine 10 does not require any form of energy aside from wind energy to operate. In order to initiate rotation of the rotor assembly 12, the vertical axis wind turbine 10 is exposed to wind or other airflow typically provided at a perpendicular direction relative to the central axis Y. As described above, the wind vane 78 automatically moves and aligns itself with the direction of the relative wind RW. Therefore, as the wind vane 78 rotates, the cam 80 affixed therewith rotates which positions the shaped interior track in the ideal arrangement which will simultaneously position each blade 36 angle of attack or attitude to maximize lift and rotational force about the central axis Y. Thus, as the direction of the relative wind changes, the cam 80 and interior track 100 autonomously adjust via the wind vane 78 to accommodate and facilitate the maximum amount of rotational force. By way of the drive gear 24, the rotational mechanical energy is transferred to the electric generator 18 via the generator gear 22 and drive shaft 20. Thereafter, the electrical energy generated by the generator 18 can be supplied to an existing electrical grid or be store by way of batteries.

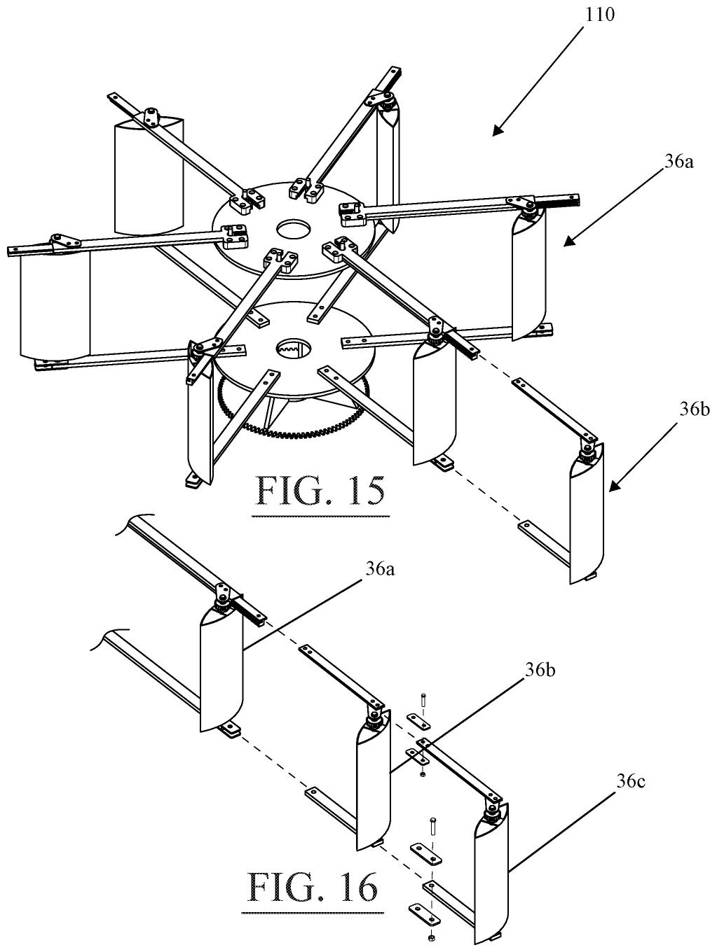

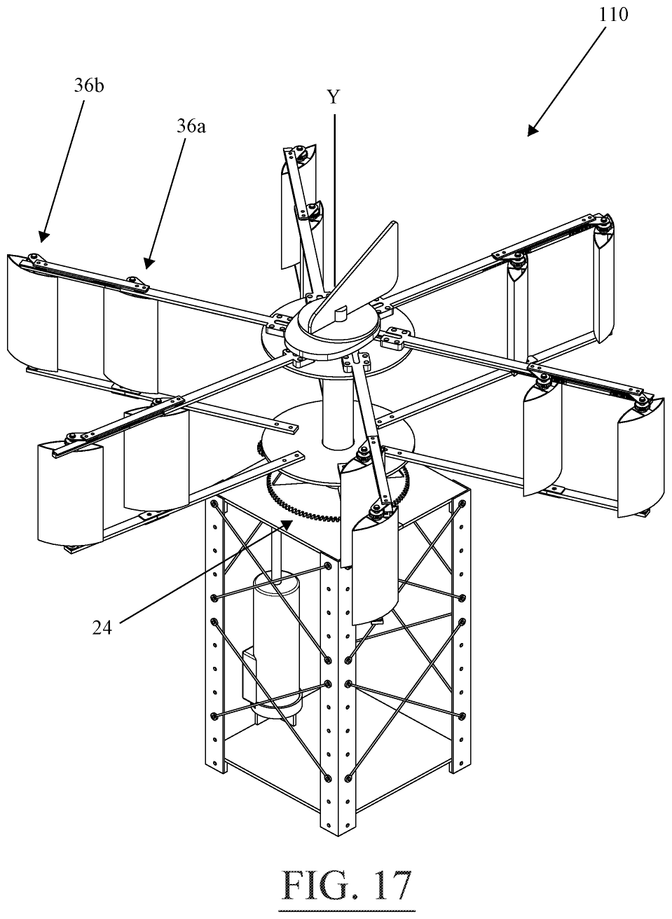

Now referring specifically to FIG. 15-FIG. 17, a version of the vertical wind turbine 200 may bolster several tiers of radial blade groupings. For example, FIG. 17 shows the turbine 200 having a first tier plurality of blades 36a and an outer second tier plurality of blades 36b. Providing multiple tier blade groups provides an option to increase the rotational force or thrust about the central axis Y. FIG. 16 partially illustrates how a third tier plurality of blades 36c may be added.

Preferably, the construction of the vertical wind turbine 10 is formed by a combination of materials—namely, carbon fiber, plastics, metals and lightweight, yet strong materials. Preferably, the blades 36 are manufactured of either Stainless Steel, Aluminum, and/or Tungsten.

The invention does not require that all the advantageous features and all the advantages need to be incorporated into every version of the invention.

Although preferred embodiments of the invention have been described in considerable detail, other versions and embodiments of the invention are certainly possible. Therefore, the present invention should not be limited to the described embodiments herein.

All features disclosed in this specification including any claims, abstract, and drawings may be replaced by alternative features serving the same, equivalent or similar purpose unless expressly stated otherwise.

What is claimed is:

1. A vertical axis wind turbine comprising:
a central axis that extends in a substantially vertical direction;
a support framework;
a fixed central spindle supported by the support framework;
a rotor assembly comprising:
a hub assembly disposed about the central axis;
a plurality of blades disposed about the central axis, the plurality of blades physically coupled to rotate together about the central axis, each blade having a blade axis about which it rotates; and
a plurality of spaced apart arm assemblies connecting the plurality of blades to the hub assembly;
an angle adjustment mechanism that is configured to adjust an angle formed between each blade and a radius that extends from the central axis to each blade as the blade rotates about the central axis and as relevant wind velocity and direction changes; the angle adjustment mechanism comprising:
a wind vane adaptable to rotate freely about the central axis so as to be substantially aligned with the direction of the wind;
at least one cam having a contoured perimeter affixed below the wind vane and disposed about the central axis, wherein the cam rotates in conjunction the wind vane in relation to the direction of the wind, the cam having an interior track operably disposed about the contoured perimeter thereof;
a cam bearing operably providing rotation of the wind vane and cam with and relative to the fixed central spindle;
a pushrod operably connecting each blade angle with the cam having a proximal end and a distal end; and
a track follower operably positioned at the proximal end of each pushrod and operably coupled to follow the interior track throughout the rotational path of the rotor assembly; and
wherein each of the blades are responsive to rotation throughout the cyclical path of the rotor assembly to vary the blade angle of each blade with respect to the direction of the wind impinging on wind vain.

2. The vertical axis wind turbine of claim 1, further comprising an electric generator having a drive shaft; and a drive gear operably affixed to the rotor assembly rotatable about the central axis and operably configured to provide rotational force to the drive shaft of the electric generator.

3. The vertical axis wind turbine of claim 2, further comprising a battery operably coupled with the electric generator for storing electrical energy.

4. The vertical axis wind turbine of claim 2, further comprising an electrical grid operably coupled with the electric generator for conducting electrical energy from the electric generator.

5. The vertical axis wind turbine of claim 1, further comprising a rotor bearing for supporting and providing rotation of the rotor assembly throughout its rotational path of motion, the rotor bearing affixed below the rotor assembly and operably affixed to the elevated platform of the support framework.

6. The vertical axis wind turbine of claim 5, wherein the rotor bearing comprises an outer race, inner race, a cage retainer, and a plurality of balls, wherein the outer race is operably affixed to the support framework and the inner race is operably affixed to the rotor assembly.

7. The vertical axis wind turbine of claim 5, wherein the rotor bearing is an angular bearing.

8. The vertical axis wind turbine of claim 5, wherein the cam bearing comprises an outer race, inner race, a cage retainer, and a plurality of balls, wherein the outer race is operably affixed to the distal end of the central spindle and the inner race is operably affixed to the cam and wind vane.

9. The vertical axis wind turbine of claim 1, wherein the cam bearing comprises an outer race, inner race, a cage retainer, and a plurality of balls, wherein the outer race is operably affixed to the distal end of the central spindle and the inner race is operably affixed to the cam and wind vane.

10. The vertical axis wind turbine of claim 1, wherein the cam bearing is an angular bearing.

11. The vertical axis wind turbine of claim 1, further comprising a pivot connection operably connecting the distal end of the pushrod and operation of the blade angle, the pivot connection having a rack and pinion type configuration.

12. The vertical axis wind turbine of claim 1, wherein the rotor assembly comprises a first tier plurality of blades and a second tier of plurality of blades disposed radially about the central axis and operably positioned in line with the respective first tier plurality of blades.

13. A vertical axis wind turbine comprising:
a central axis that extends in a substantially vertical direction;
a support framework;
a fixed central spindle having a distal end and supported by the support framework;
an electric generator having a drive shaft;
a rotor assembly comprising:
a hub assembly disposed about the central axis;
a plurality of blades disposed about the central axis, the plurality of blades physically coupled to rotate together about the central axis, each blade having a blade axis about which it rotates; and
a plurality of spaced apart arm assemblies connecting the plurality of blades to the hub assembly;
a rotor bearing for supporting and providing rotation of the rotor assembly throughout its rotational path of motion, the rotor bearing operably affixed below the rotor assembly and operably attached to the elevated platform of the support framework, the rotor bearing having an outer race, inner race, a cage retainer, and a plurality of balls, wherein the outer race is operably affixed to the elevated platform and the inner race is operably affixed to the rotor assembly;
a drive gear operably affixed to the rotor assembly rotatable about the central axis and configured to provide rotational force to the drive shaft of the electric generator; and
an angle adjustment mechanism that is configured to adjust an angle formed between a blade and a radius that extends from the central axis to the blade as the blade rotates about the central axis and as relevant wind velocity and direction changes; wherein the angle adjustment mechanism comprises:
a wind vane adaptable to rotate freely about the central axis so as to be substantially aligned with the direction of the wind;
at least one cam having a contoured perimeter affixed below the wind vane and disposed about the central axis, wherein the cam rotates in conjunction the wind vane in relation to the direction of the wind, the cam having an interior track operably disposed about the contoured perimeter thereof;
a cam bearing operably providing rotation of the wind vane and cam relative to the fixed central spindle, the bearing having an outer race, inner race, cage retainer, plurality of balls, and lubrication, wherein the outer race is operably affixed to the distal end of the central spindle and the inner race is operably affixed to the cam and wind vane;
a pushrod operably connecting the blade angle with the cam having a proximal end and a distal end;
a track follower operably positioned at the proximal end of each pushrod and operably coupled to follow the interior track throughout the rotational path of the rotor assembly; and
a pivot connection operably connecting the distal end of the pushrod and operation of the blade angle, the pivot connection having a rack and pinion type configuration;
wherein each of the blades are responsive to rotation throughout the cyclical path of the rotor assembly to vary the blade angle of each blade with respect to the direction of the wind impinging on wind vain.

14. The vertical axis wind turbine of claim 13, wherein the rotor assembly comprises a first tier plurality of blades and a second tier of plurality of blades disposed radially about the central axis and operably positioned in line with the respective first tier plurality of blades.

15. The vertical axis wind turbine of claim 13, further comprising a battery operably coupled with the electric generator for storing electrical energy.

16. The vertical axis wind turbine of claim 13, further comprising an electrical grid operably coupled with the electric generator for transferring electrical energy from the electric generator.
